(19) United States
(12) Patent Application Publication
(10) Pub. No.: US 2019/0162871 A1
(43) Pub. Date: May 30, 2019

(54) Determining Characteristics Of A Fracture

(71) Applicant: Halliburton Energy Services, Inc., Houston, TX (US)

(72) Inventors: Dustin Myron Dell, Duncan, OK (US); Ahmed El Demerdash, Houston, TX (US); Wei-Ming Chi, Houston, TX (US); Jim Basuki Surjaatmadja, Duncan, OK (US); Bryan John Lewis, Duncan, OK (US)

(21) Appl. No.: 16/323,129

(22) PCT Filed: Sep. 30, 2016
(86) PCT No.: PCT/US2016/054786

§ 371 Date: Feb. 4, 2019

(51) Int. Cl. G01V 3/30; E21B 47/06

(52) U.S. Cl. CPC G01V 3/30; E21B 47/122; E21B 47/06

(57) ABSTRACT

A system for determining characteristics of a fracture can include electromagnetic sensors and a pressure sensor. The electromagnetic sensors can be positioned in a wellbore having a perforation to determine an amount of flow traversing the perforation into a fracture zone. The electromagnetic sensors can include a first electromagnetic sensor positioned in a first segment of the wellbore that is closer than the perforation to a surface of the wellbore. The electromagnetic sensors can also include a second electromagnetic sensor that is positioned in a second segment of the wellbore that is farther than the perforation from the surface of the wellbore. The pressure sensor can be positioned in the wellbore for detecting a pressure wave generated by the flow. The pressure wave and the amount of the flow traversing the perforation can be used to determine a characteristic of a fracture in the fracture zone.

### TECHNICAL FIELD

The present disclosure relates generally to a device for use in a wellbore, and more particularly (although not necessarily exclusively), to using electromagnetic sensors and a pressure sensor to determine characteristics of a fracture.

### BACKGROUND

In a wellbore environment, such as an oil or gas well for extracting hydrocarbon fluids from a subterranean formation, hydraulic fracturing, also known as fracking, can be performed to improve production. Fracking can include pumping treatment fluid into a wellbore to cause fractures to form in the subterranean formation. Perforations can be created in the wellbore so that formation fluid can more easily flow and enter the wellbore through the perforations. The fractures can grow at various rates and directions. The treatment fluid can include a proppant, which is particulate of a given particle size range that can enter the fractures under pressure of the treatment fluid to “prop” the fractures open.

### BRIEF DESCRIPTION OF THE DRAWINGS

FIG. 1 is a cross-sectional example of a wellbore with an assembly for determining characteristics of a fracture according to one aspect of the present disclosure.

FIG. 2 is a perspective view of an example of an assembly for determining characteristics of a fracture according to one aspect of the present disclosure.

FIG. 3 is a block diagram of an example of an assembly for determining characteristics of a fracture according to one aspect of the present disclosure.

FIG. 4 is a flow chart of an example of a process for determining characteristics of a fracture according to one aspect of the present disclosure.

FIG. 5 is a flow chart of an example of a process for determining characteristics of a fracture according to one aspect of the present disclosure.

### DETAILED DESCRIPTION

Certain aspects and features relate to determining characteristics of a fracture using electromagnetic sensors and a pressure sensor. The electromagnetic sensors and the pressure sensor can be positioned in a wellbore formed through a subterranean formation. A fracking operation can be performed to form the fracture in a portion of the subterranean formation that can be referred to as the fracture zone. Treatment fluid can be pumped through a perforation in the wellbore and into the fracture zone at a portion of the wellbore that can be referred to as the stimulation zone. The electromagnetic sensors can be positioned to determine an amount of the treatment fluid traversing the perforation into the fracture zone. The pressure sensor can be positioned in the wellbore to detect pressure waves (e.g., acoustic noise) generated by the treatment fluid traversing the perforation and moving in the fracture zone. The amount of treatment fluid entering the fracture zone and the pressure waves can be used to determine characteristics of the fracture.

In some aspects, the treatment fluid can have a predetermined ratio of a conductive material. The conductive material can be a proppant (e.g., sand, plastic, or ceramic) treated with an electrically conductive coating. The electromagnetic sensors can measure data (e.g., a density) about the conductive material as the conductive material moves through an electromagnetic field. The data can be used to determine an amount of treatment fluid traversing the electromagnetic field. In some aspects, an electromagnetic sensor can be positioned in the wellbore to measure a density of the conductive material at a position that is closer than the perforation to the surface of the wellbore. The other electromagnetic sensor can be positioned in the wellbore to measure a second density of the conductive material at a position farther than the perforation from the surface of the wellbore. The difference in the measured densities can be used to determine an amount of the treatment fluid traversing the perforation and into the fracture zone. In some aspects, the electromagnetic sensors are retained at a central position in the wellbore by centralizer loops that can extend from the electromagnetic sensors and press against the walls of the wellbore.

In some aspects, the pressure sensor can detect high-frequency (e.g., greater than 100 Hz) pressure waves generated from the treatment fluid traversing the perforations or from the treatment fluid moving in the fracture zone. More than one pressure sensor can be positioned in the wellbore and the location of an origin of the pressure wave can be determined by detecting the pressure wave by the pressure sensors. Perforations identified as having treatment fluid flowing therethrough can be used to determine the effectiveness of diversion techniques applied during the stimulation. Locations in the fracture zone that are determined to be an origin of a pressure wave can be used to determine a location of a fracture. Furthermore, the source of pressure waves can be analyzed to verify that complete diversion was achieved on previous fractures.

The position and movement of the proppant face and fracture tip can be identified by analyzing the resonance reflection of pressure waves. A frequency-amplitude spectrum of the pressure fluctuations can be determined from the pressure wave. The natural hydraulic frequencies of a fracture zone can be identified in the frequency-amplitude spectrum. The natural hydraulic frequencies can be excited by the broadband noise generated from the movement of the treatment fluid causing the natural hydraulic frequencies to have the highest amplitudes in the frequency-amplitude spectrum. A change in the natural frequencies of a fracture zone can be used to determine fracture growth in the fracture zone. In some aspects, as proppant fills the fracture zone the natural frequency can change. Operators can detect the change in the natural frequency by using the pressure sensor, which can allow operators to determine, in substantially real-time, when to stop pumping the treatment fluid.

In some aspects, using electromagnetic sensors and a pressure sensor positioned in a wellbore can allow for simultaneous measuring of different characteristics of the flow. Measuring the different characteristics can allow for determining, in substantially real-time, characteristics of hydraulic fractures in a subterranean formation during stimulation. These characteristics can include, but are not limited to, an amount of treatment fluid entering a fracture, an extension of a fracture tip, fracture branching, fracture volume, proppant face, proppant deviation, and a location of a perforation allowing treatment fluid to pass therethrough. In some aspects, the electromagnetic sensors can scan the casing of the wellbore for defects as they are moved to a position in the stimulation zone of the wellbore. In additional or alternative aspects, the electromagnetic sensors can measure a distribution of conductive material in the fracture zone that can be used to determine a connected stimulated reservoir volume (“CSRV”).

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

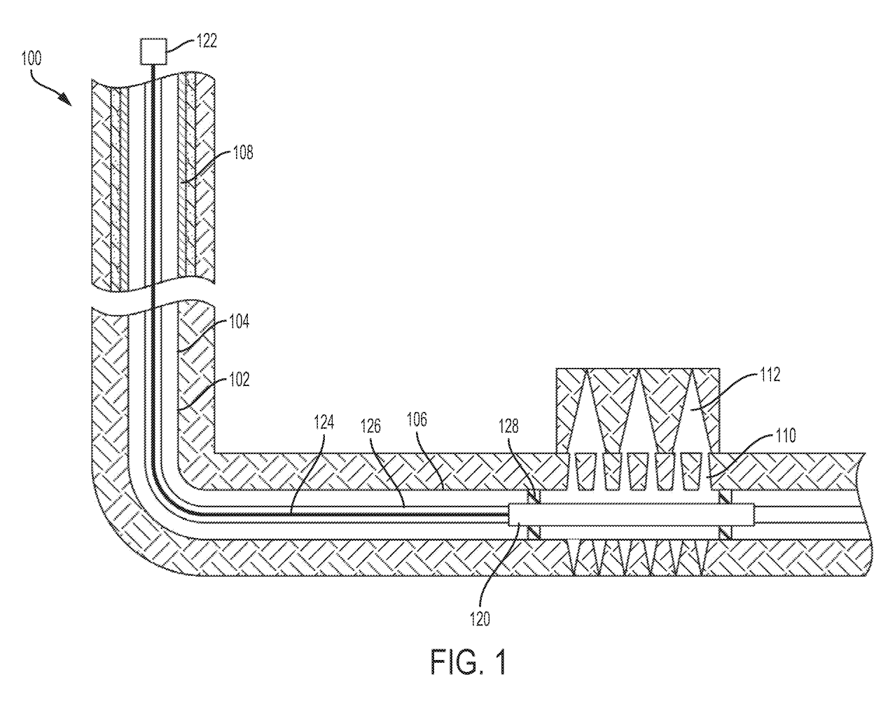

FIG. 1 is a cross-sectional diagram of an example of a wellbore environment 100 with an assembly 120 for determining characteristics of fractures 112. The wellbore environment 100 can include a wellbore 102 with a substantially vertical section 104 and a substantially horizontal section 106. The substantially vertical section 104 and the substantially horizontal section 106 can include a casing string 108 cemented at an upper segment of the substantially vertical section 104. Perforations 110 can exist in a stimulation zone of the wellbore 102 and form a passage between an inner area of the wellbore 102 and fractures 112.

The assembly 120 can be positioned in the stimulation zone and communicatively coupled to a processing device 122 by a cable 124 (e.g., a fiber optic cable). The cable 124 can be positioned in a tubing string 126 (e.g., a coiled tubing) extending from a surface of the wellbore 102 to the assembly 120. Packers 128 (e.g., inflatable packers) can be coupled to the assembly 120 for sealing the stimulation zone from other sections of the wellbore 102.

Treatment fluid can be pumped into the stimulation zone to stimulate the radially adjacent subterranean formation. The treatment fluid can pass through the perforations 110 into the fracture zone and can cause fractures 112 to grow as well as cause new fractures to form. In some aspects, the treatment fluid can flow through tubing string 126 and assembly 120, which can have an opening for allowing a portion the treatment fluid to move from an inner area of the assembly 120 to an area external to the assembly 120 in the stimulation zone. In additional or alternative aspects, the treatment fluid can flow to the stimulation zone through another tubing string or in an area external to the tubing string 126. The treatment fluid can include a conductive material. The conductive material can be a proppant for propping open the fractures 112.

In some aspects, the assembly 120 can include electromagnetic sensors for detecting conductive material as the conductive material passes through an electromagnetic field. In some aspects, the assembly 120 can include electromagnetic field generators for producing electromagnetic fields. The electromagnetic sensors or electromagnetic field generators can be retained at a position in the wellbore 102 by centralizer loops that can extend from the assembly 120 and can press against the walls of the wellbore.

The electromagnetic sensors can be used to measure data about the conductive material in a section of the wellbore 102 that is closer than the perforations 110 to the surface. The electromagnetic sensors can also be used to measure data about the conductive material in another section of the wellbore 102 that is farther than the perforations 110 from the surface. The difference between these two measurements can be used to determine an amount of conductive material traversing the perforation 110 into the fracture zone. In some aspects, the electromagnetic sensor can detect a distribution of the conductive material in the fracture zone, and the distribution can be used to determine characteristics of the fractures 112 in the fracture zone.

In some additional or alternative aspects, the assembly 120 can include a pressure sensor. The pressure sensor can detect pressure waves generated from the treatment fluid traversing the perforations 110 or moving in the fracture zone. The pressure wave can be analyzed to determine a natural hydraulic frequency of the fracture zone. Changes in the natural hydraulic frequency of the fracture zone can be used to determine changes in fractures 112. In some aspects, the assembly 120 can include an oscillator for generating a steady pressure oscillation at a known frequency. The frequency can be adjusted and the pressure sensor can measure a response of the wellbore environment 100. The processing device 122 can determine the natural frequency of the wellbore environment 100 based on the response.

The pressure sensor can also detect a reflection of a pressure pulse signal propagating through the fracture zone. The pressure pulse signal can be a water hammer generated by a change in the pumping rate of the treatment fluid. The reflection of the pressure pulse signals can be used to determine characteristics of fractures 112. In some aspects, the assembly 120 can include more than one pressure sensor and the origin of a pressure wave can be determined by detecting the pressure wave with more than one pressure sensor.

Although FIG. 1 depicts the assembly 120 having a tubular body coupled to a tubing string 126, a system can have electromagnetic sensors and a pressure sensor positioned in a wellbore for determining characteristics of a fracture. In some aspects, more than one assembly can be positioned in a wellbore. In additional or alternative aspects, an assembly can be positioned in a simpler wellbore, such as a wellbore having only a vertical section. In some aspects, an assembly can be positioned in an open-hole environment wellbore. In additional or alternative aspects, an assembly can be positioned in a lateral bore of a multilateral wellbore.

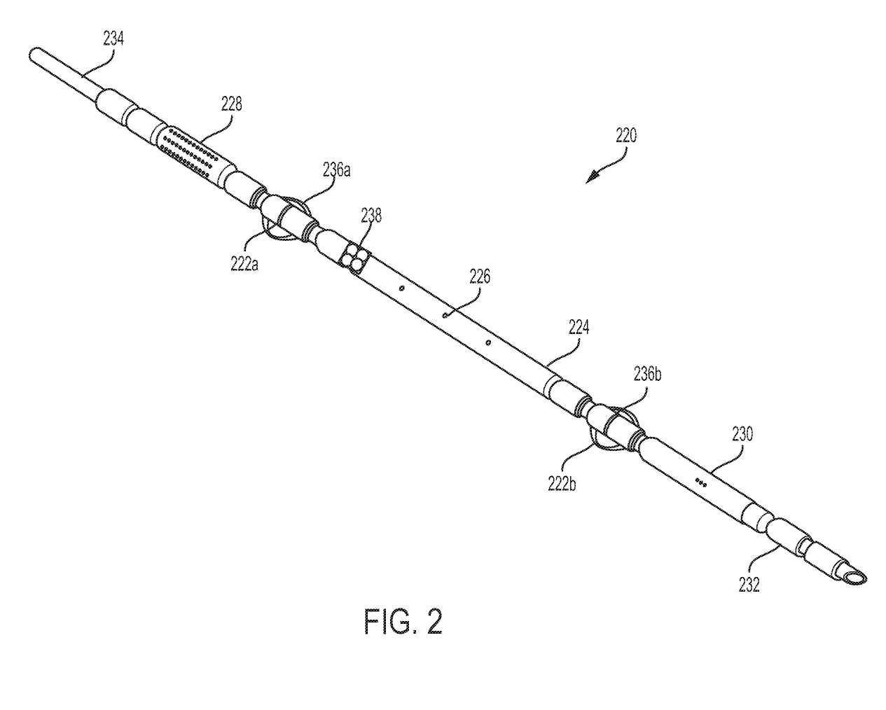

FIG. 2 is a perspective view of an example of an assembly 220 for determining characteristics of fractures in a subterranean formation. The tool can have a pair of electromagnetic arrays 222a-b each coupled to an end of a tubular body 224 with openings therein. A pressure sensor array 226 can be coupled to the tubular body 224. The assembly 220 can further include a hydra jet 230 coupled to the tubular body 224, inflatable packers 232, a diverter 228, coiled tubing 234, and an oscillator 238.

The coiled tubing 234 can be used to position a segment of the assembly 220 in a stimulation zone of the wellbore. The hydra jet 230 can be activated to create perforations in the radially adjacent inner surface of the wellbore. The inflatable packers 232 can expand to seal the stimulation zone from another portion of the wellbore. In some aspects, the coiled tubing 234 can further be used to allow treatment fluid to flow therethrough. A portion of the treatment fluid can flow through the hydra jet 230 or other openings in the assembly 220 and flow into the stimulation zone. The portion of the treatment fluid can flow through the perforations and into fractures in the subterranean formation. The treatment fluid can include conductive material (e.g., proppant with an electrically conductive coating). The diverter 228 can be activated in response to a fracture beginning to screen-out prematurely. The diverter 228 can open up above the perforations and send any remaining conductive material to the surface via an annulus, which can be the area between the coiled tubing 234 and a wall of the wellbore. In additional or alternative aspects, a slurry can be pumped into the wellbore through the coiled tubing 234 and water can be pumped into the wellbore through the annulus.

The electromagnetic arrays 222a-b can include an electromagnetic field generator and an electromagnetic sensor for measuring data about the conductive material in the flow at a position up-stream (e.g., closer to the source) from the perforations and for measuring a data about the conductive material at position down-stream (e.g., farther from the source) from the perforations. The electromagnetic arrays 222a-b can further be used to determine a distribution of the conductive material in a fracture zone. The electromagnetic arrays 222a-b can also be used to scan the wellbore as the assembly 220 is moved through the wellbore. The electromagnetic arrays 222a-b can further include (or be coupled to) centralizer loops 236a-b. The centralizer loops 236a-b can press against the walls of the wellbore to retain the electromagnetic arrays 222a-b near the center of the wellbore (e.g., at a position along a longitudinal axis of the wellbore).

The pressure sensor array 226 can include any number of optical or electronic pressure sensors for detecting pressure waves (e.g., acoustic noise) generated from the treatment fluid traversing the perforation or moving in the fracture zone. The oscillator 238 can generate a steady pressure oscillation for determining the natural frequency of the fracture zone based on a response of the fracture zone to changes in the frequency of the steady pressure oscillation.

Although FIG. 2 depicts assembly 220 having two electromagnetic arrays 222a-b, each including an electromagnetic field generator and an electromagnetic sensor, an assembly can include any number of electromagnetic arrays each having any number of electromagnetic sensors or electromagnetic field generators. For example, an assembly can have one electromagnetic generator for generating an electromagnetic field both up-stream and down-stream from the perforations.

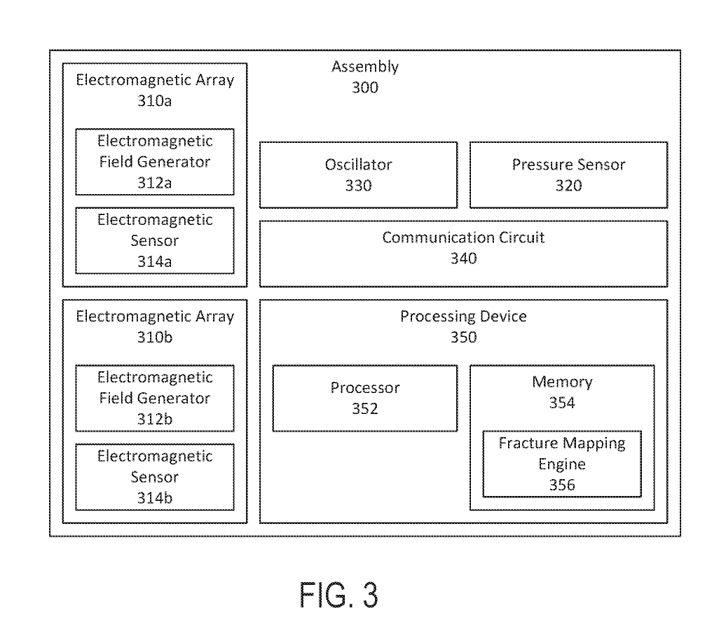

FIG. 3 is a block diagram of an assembly 300 that can be positioned downhole for determining characteristics of a fracture in a fracture zone radially adjacent to a wellbore. The assembly 300 can include electromagnetic arrays 310a-b, a pressure sensor 320, an oscillator 330, communication circuit 340, and a processing device 350.

The electromagnetic arrays 310a-b can be used to measure data about a treatment fluid passing through a perforation in the wellbore to the fracture zone. The electromagnetic arrays 310a-b can each include an electromagnetic field generator 312a-b and an electromagnetic sensor 314a-b. One of the electromagnetic field generators 312a-b can generate an electromagnetic field in a segment of a wellbore that is closer than the perforation to a surface of the wellbore. The other electromagnetic field generator 312a-b can generate an electromagnetic field in a segment of the wellbore that is farther than the perforations to the surface of the wellbore.

The electromagnetic sensors 314a-b can each measure data about conductive material flowing through an electromagnetic field. One of the electromagnetic sensors 314a-b can measure a data about conductive material in the treatment flow passing through the electromagnetic field that is closer than the perforation to the surface. The other electromagnetic sensor 314a-b can measure data about conductive material in the treatment flow passing through the other electromagnetic field that is farther than the perforation from the surface. The difference in these densities can be used to determine an amount of conductive material flowing through the perforation. In some aspects, the treatment fluid has a known proportion of the conductive material such that the difference in densities can be used to determine an amount of treatment fluid traversing the perforation into the fracture zone. The accuracy of the data can be improved by retaining the electromagnetic sensors 314a-b at a position near a central axis of the wellbore. The assembly 300 can include centralizer loops for extending from the assembly 300 and pressing into a wall of the wellbore to limit the movement of the assembly 300.

The electromagnetic arrays 310a-b can also be used to determine a distribution of the conductive material in the fracture zone by generating an electromagnetic field that encompasses the fracture zone and detecting the position of the conductive material in the electromagnetic field. The distributed position of the conductive material can be used to determine the CSRV. Branch fractures created that were either not propped open or were not fully connected to the main fracture network may not be detected, as there may be no conductive path in the proppant. This distributed position of the conductive material can also be used to adjust subsequent treatment schedules for fracture zones in the wellbore.

The pressure sensor 320 can detect high-frequency (e.g., greater than 100 Hz) pressure waves generated from the treatment fluid traversing the perforations or in the fracture zone. In some aspects, more than one pressure sensor can be positioned in the wellbore, and the location of an origin of the pressure wave can be determined by detecting the pressure wave with more than one pressure sensor. Perforations identified as having treatment fluid flowing therethrough can be used to determine the effectiveness of diversion techniques applied during the stimulation. Locations in the fracture zone that are determined to be an origin of a pressure wave can be used to determine a location of a fracture. Furthermore, the source of pressure waves can be analyzed to verify that complete diversion was achieved on previous fractures.

The pressure sensor 320 can also detect a reflection of a pressure pulse signal. In some aspects, a pressure pulse signal can be generated at the conclusion of each stimulation phase (e.g., a change in the pumping rate of the treatment fluid). The pressure pulse signal can be a hydraulic pulse (e.g., a water hammer) transmitted down the wellbore from the surface. As the pressure pulse reflects off parts of the wellbore and the fractures, reflections are formed. The pressure sensor 320 can detect these reflections. The magnitude, time shift, and signal decay of the reflections can be represented as a resistance-capacitance-impedance network. The reflections can be used to approximate fracture length, fracture height, and fracture width. The oscillator 330 can generate a steady pressure oscillation at a known frequency. The frequency can be adjusted and the pressure sensor 320 can measure a response of the wellbore environment. The processing device 350 can determine the natural frequency of the wellbore environment based on the response. Changes in the natural frequency can be used to determine changes in the fractures.

The communication circuit 340 can communicate information based on the measurements from the electromagnetic sensors 314a-b and pressure sensor 320 to other devices (e.g., a transceiver at the surface of the wellbore). In some aspects, the communication circuit 340 can be communicatively coupled to a wireline (e.g., a fiber optic cable) for communicating the information. In additional or alternative aspects, the communication circuit 340 can include (or be communicatively coupled to) an antenna for wirelessly communicating the information.

The processing device 350 can include any number of processors 352 for executing program code. Examples of the processing device 350 can include a microprocessor, an application-specific integrated circuit (“ASIC”), a field-programmable gate array (“FPGA”), or other suitable processing device. In some aspects, the processing device 350 can be a dedicated processing device for determining characteristics of the fractures based on measurements from the electromagnetic sensors 314a-b and pressure sensor 320. In other aspects, the processing device 350 can be used for controlling fracking operations (e.g., adjusting a pumping rate, activating a fluid diverter, or activating an inflatable packer).

The processing device 350 can include (or be communicatively coupled with) a non-transitory computer-readable memory 354. The memory 354 can include one or more memory devices that can store program instructions. The program instructions can include, for example, a fracture mapping engine 356 that can be executed by the processing device 350 to perform certain operations described herein.

In some aspects, the operations can include instructing the electromagnetic sensors 314a-b to scan a casing of the wellbore for defects as the assembly 300 is moved through the wellbore. The operations can also instruct a pump to be activated for pumping a conductive material into a stimulation zone of the wellbore. The stimulation zone can have one or more perforations. The perforations can form a passage between an inner area of the wellbore and a fracture zone. A portion of the conductive material can move through the perforations into the fracture zone.

In additional or alternative aspects, the operations can include instructing electromagnetic arrays 310a-b and pressure sensor 320 to measure information about the flow. The electromagnetic array 310a can be instructed to generate an electromagnetic field at a position in the tubular body that is closer than the perforations to the surface and to measure first data about the conductive material passing through the electromagnetic field. Electromagnetic array 310b can be instructed to generate an electromagnetic field at a position in the tubular body that is farther than the perforations from the surface and to measure second data about the conductive material passing through the electromagnetic field. An amount of the flow entering the fracture zone through the perforations can be determined based on data about the conductive material in the tubular member at a position closer to the surface and data about the conductive material at a position farther from the surface than the perforations. Electromagnetic arrays 310a-b can also be instructed to measure a distribution of the conductive material in the wellbore. The pressure sensor 320 can be instructed to detect a pressure wave generated from the portion of the conductive material traversing the perforation or from the portion of the conductive material traversing the fracture zone.

In additional or alternative aspects, the operations can further instruct a signal based on the first data, the second data, the pressure wave, the distribution of the conductive material, or the reflection of the pressure pulse signal to be transmitted to a transceiver at a surface of the wellbore. The operations can also include determining a characteristic of the fracture zone based on the first data, the second data, the pressure wave, the distribution of the conductive material, or the reflection of the pressure pulse signal.

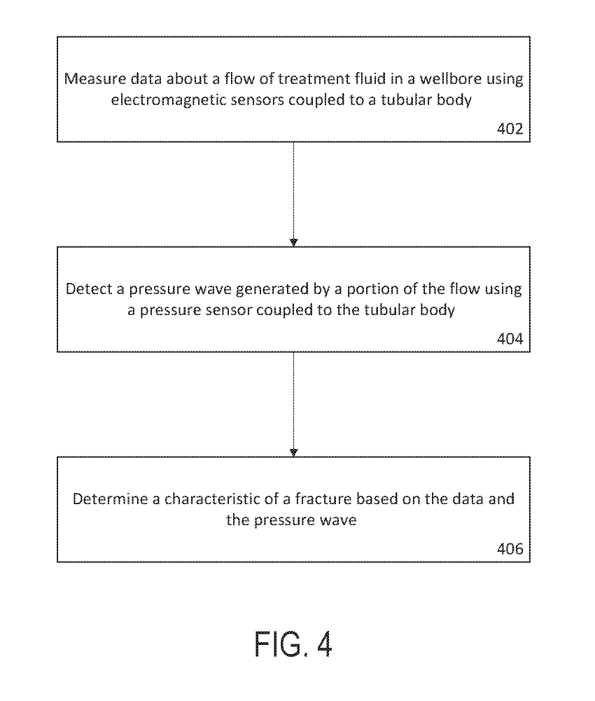

FIG. 4 is a flow chart of an example of a process for determining characteristics of a fracture. Determining characteristics of the fracture can permit wellbore operators to estimate the effectiveness of a stimulation attempt. The characteristics of the fracture can also be determined in substantially real-time, permitting wellbore operators to adjust a stimulation attempt based on the changes in a fracture zone.

In block 402, data about a flow of treatment fluid is measured in a wellbore using electromagnetic sensors coupled to a tubular body. The flow of treatment fluid is allowed to pass through the tubular body positioned in a wellbore. The treatment fluid can include a proppant that can be a conductive material. A portion of the flow can enter a perforation in a wall of the wellbore. The electromagnetic sensors can measure data about the flow to determine an amount of the flow traversing the perforation. In some aspects, the electromagnetic sensors can measure an amount of the flow at a first segment of the tubular body that is closer than the perforation to a source of the flow. In additional or alternative aspects, the electromagnetic sensors can measure the amount of the flow at a second segment of the tubular body that is farther than the perforation from the source of the flow. The difference in the amount of the flow at the first segment and the amount of the flow at the second segment can be used to determine the amount of the flow traversing the perforation.

The perforation can form a passage to a fracture zone such that the portion of the flow can move through the perforation into the fracture zone. In some aspects, the tubular body can have one or more openings therethrough for allowing the portion of the flow to move from an inner area of the tubular body to an outer area of the tubular body that is substantially adjacent to the perforation. In additional or alternative aspects, packers can be coupled to the outer surface of the tubular body to seal the outer area of the tubular member from other sections of the wellbore.

In block 404, a pressure wave (e.g., acoustic noise) generated by the flow is detected by a pressure sensor. The pressure wave can be generated by the portion of the flow traversing the perforation or by the portion of the flow moving in the fracture zone. In some aspects, the pressure sensor can be a high-frequency (e.g., greater than 100 Hz) pressure sensor positioned downhole.

The position and movement of the proppant face and fracture tip can be identified by analyzing the resonance reflection of pressure waves inside the wellbore. A Fourier Transformation of the high-frequency pressure signal can result in a frequency-amplitude spectrum of the pressure fluctuations. The natural hydraulic frequency of the system can be excited by the broadband noise being generated by the treatment fluid flowing into the perforations. Given the broadband excitation, the frequency spectrum can highlight the natural frequencies, as they can be of the largest amplitudes. By repeating the Fourier analysis of the pressure signal through the stimulation treatment, the change in natural frequencies can be identified. The change in natural frequencies can be a result of change in volume of the fracture. Therefore, by comparing the change in natural frequency of the hydraulic system, the fracture growth can be determined.

In some aspects, an oscillator can be used to monitor changes in the natural frequency of the system. The oscillator can be coupled to the tubular body and positioned in the wellbore for generating a steady pressure oscillation at a specific frequency. The frequency can be adjusted and the pressure sensor can measure a response of the wellbore environment to the change in the frequency of the pressure oscillation. The natural hydraulic frequency of the system can be determined based on the systems response.

In addition, the proppant face can be determined as the fracture is filled by identifying another change in the natural frequency as the proppant begins to fill the fracture. In some examples, the fracture dimensions can be estimated and operators can more accurately identify screen-outs. Positioning the pressure sensor in the wellbore can improve near-wellbore conductivity and well performance. In an event that the fracture begins to screen-out prematurely a fluid diverter can be activated above the perforations and send any remaining proppant or conductive material that is in the wellbore back up into the coiled tubing. This can prevent screen-out and allow the fracture area to be optimally connected to the wellbore.

In some aspects, more than one pressure sensor can be positioned in the wellbore and the location of the origin of the pressure wave can be determined by detecting the pressure wave with more than one pressure sensor. In some aspects, more than one perforation can exist in the wellbore. Identifying an active perforation can be used to determine an effectiveness of diversion techniques applied during the stimulation to improve total well stimulation. Identifying a pressure wave as originating from the fracture zone can indicate a new fracture was initiated after a diverter (e.g., BioVert NWB) was applied, as well as identifying a location of the new fracture. Monitoring the origins of pressure waves can allow for analysis of whether a complete diversion was achieved on the previous fracture.

In block 406, a characteristic of the fracture can be determined based on the data and the pressure wave. In some aspects, the characteristic can be determined by a processing device coupled to the tubular body. In additional or alternative aspects, the processing device can be positioned external to the wellbore. A communication circuit can be coupled to the tubular body for communicating information based on the data or the pressure wave to the processing device wirelessly or over a cable. The characteristic of the fracture can be determined in substantially real-time and used to adjust stimulation of the fractures. Alternatively, information based on the data and the pressure wave can be stored to a memory and later retrieved for determining a characteristic of the fracture. In some aspects, a plurality of characteristics of the fracture and the stimulation zone can be determined. For example, the data and the pressure wave can be used to determine extension of the fracture tip, fracture branching, fracture volume, proppant face, proppant deviation, perforation location, the amount of a treatment fluid moving into the fracture, and the amount of treatment fluid leaking past a packer.

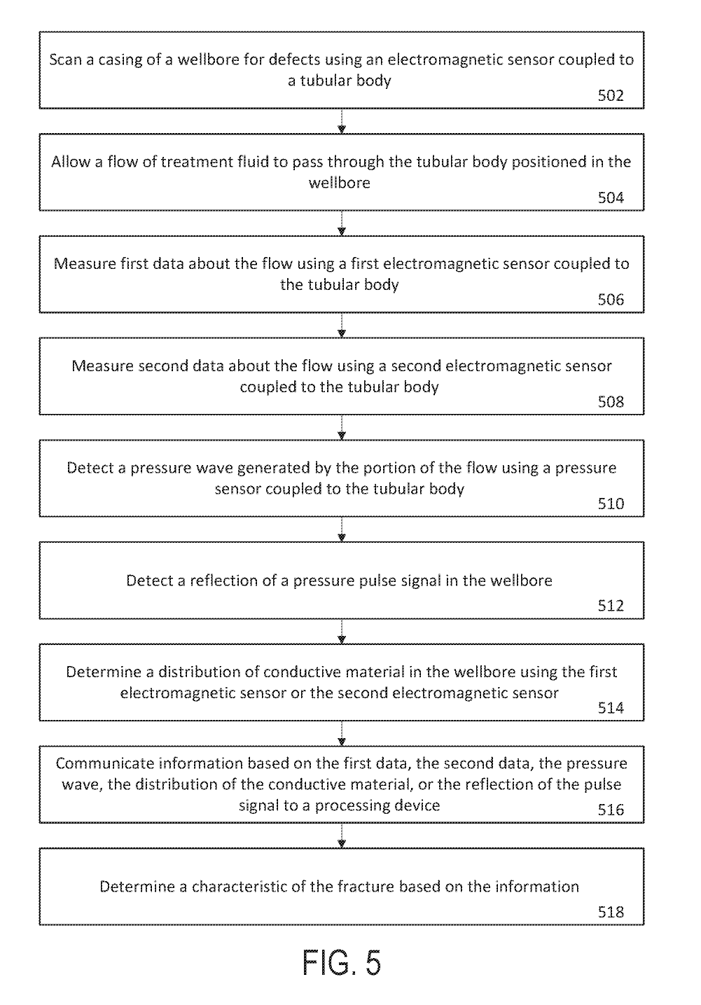

FIG. 5 is a flow chart of another example of a process for determining characteristics of a fracture. In block 502, a casing of a wellbore is scanned for defects using an electromagnetic sensor coupled to a tubular body. The electromagnetic sensors can scan for leaks as the tubular body is moved through the wellbore. In block 504, a flow is allowed to pass through the tubular body positioned in the wellbore. The wellbore can include a perforation that forms a passage from an inner area of the wellbore to a fracture zone such that a portion of the flow moves through the perforation into the fracture zone. In some aspects, a wellbore can include more than one perforation that forms a passage between the inner area of the wellbore and the fracture zone.

In block 506, first data about the flow can be measured by a first electromagnetic sensor coupled to the tubular body. The first data can be measured as the flow passes through an electromagnetic field positioned in a segment of the tubular body that is closer than the perforation to a source of the flow. An electromagnetic field generator can be coupled to the tubular body for generating the electromagnetic field. The first electromagnetic sensors can detect current produced by treatment fluid having conductive material passing through the first electromagnetic field. In some aspects, the source of the conductive material can be at a surface of the wellbore such that the segment of the tubular body is closer than the perforation to the surface.

In block 508, second data about the flow can be measured by a second electromagnetic sensor coupled to the tubular body. The second data can be measured as the flow passes through an electromagnetic field positioned in a segment of the tubular body that is farther than the perforation from the source of the flow. Another electromagnetic field generator can be coupled to the tubular body for generating the electromagnetic field. The second electromagnetic sensors can detect current produced by treatment fluid having conductive material passing through the second electromagnetic field. In some aspects, the source of the conductive material can be at a surface of the wellbore such that the segment of the tubular body is farther than the perforation to the surface.

Block 510 is substantially similar to block 404 in FIG. 4. In block 510, a pressure wave is detected by a pressure sensor. In some examples, the pressure wave may have been generated from a portion of the flow traversing the perforation or the portion of the flow moving in the fracture. The pressure wave can be detected by more than one pressure sensor such that the origin of the pressure wave can be detected.

In block 512, a reflection of a pressure pulse signal can be detected. The pressure pulse signal can be generated at the surface due to changes in the pumping rate of the treatment fluid. As the pressure pulse signal reflects off obstacles in the wellbore and the fractures, the reflection can be formed. The magnitude, time shift, and signal decay of the reflection can be represented by a resistance-capacitance-impedance network that can be used to approximate a fracture length, a fracture height, and a fracture width of a fracture in the fracture zone. Multiple impulse events occurring throughout the stimulation can allow for observing the changes in fracture geometry. In some aspects, a pressure sensor positioned downhole can more accurately detect reflections from pressure pulse signals than a pressure sensor positioned at a surface of the wellbore.

In block 514, a distribution of the conductive material in the wellbore is determined by the first electromagnetic sensor or the second electromagnetic sensor. An electromagnetic field encompassing a portion of the fracture zone can be generated and the electromagnetic sensors can measure the final position of the conductive material that is located throughout the fracture. The distributed position of the conductive material can provide an accurate estimate of the CSRV. Any branch fractures created that were either not propped open or were not fully connected to the main fracture network will not be detected, as there will be no conductive path through the proppant. The distribution of the conductive material can also be used to adjust subsequent treatment schedules in the wellbore.

In block 516, information based on the first data, the second data, the pressure wave, the distribution of the conductive material, or the reflection of the pressure pulse signal is communicated to a processing device. In some aspects, the data can be communicated over a cable (e.g., a fiber optic cable) positioned in a conduit that runs from the surface through the inside diameter of the coiled tubing, terminating at the downhole tool. The cable can also provide power to the devices downhole. In additional or alternative aspects, the data can be communicated wirelessly.

In block 518, a characteristic of the fracture is determined based on the first data, the second data, the pressure wave, the distribution of the conductive material, or the reflection of the pressure pulse signal. In some aspects, using electromagnetic sensors and a pressure sensor positioned in a wellbore can allow for simultaneous measurements and substantially real-time determination of characteristics of hydraulic fractures in a subterranean formation during stimulation. These characteristics can include, but are not limited to, an amount of treatment fluid entering a fracture, an extension of a fracture tip, fracture branching, fracture volume, proppant face, proppant deviation, and a location of a perforation allowing treatment fluid to pass therethrough.

In some aspects, a tool for determining characteristics of a fracture is provided according to one or more of the following examples:

### EXAMPLE #1

A system can include electromagnetic sensors and a pressure sensor. The electromagnetic sensors can be positioned in a wellbore having a perforation to determine an amount of flow traversing the perforation into a fracture zone. The electromagnetic sensors can include a first electromagnetic sensor positioned in a first segment of the wellbore that is closer than the perforation to a surface of the wellbore. The electromagnetic sensors can also include a second electromagnetic sensor that is positioned in a second segment of the wellbore that is farther than the perforation from the surface of the wellbore. The pressure sensor can be positioned in the wellbore for detecting a pressure wave generated by the flow. The pressure wave and the amount of the flow traversing the perforation can be used to determine a characteristic of a fracture in the fracture zone.

### EXAMPLE #2

The system of Example #1, further featuring the first electromagnetic sensor being positioned in the first segment for measuring a first density of conductive material in the treatment fluid as the flow passes through a first electromagnetic field in the first segment of the wellbore. The second electromagnetic sensor being positioned in the second segment for measuring a second density of the conductive material in the treatment fluid as the flow passes through a second electromagnetic field in the second segment of the wellbore. A difference between the first density and the second density can be used to determine the amount of the flow that is traversing the perforation into the fracture zone.

### EXAMPLE #3

The system of Example #2, further featuring the first electromagnetic sensor or the second electromagnetic sensor being positioned for detecting a distribution of the conductive material in the fracture zone. The distribution of the conductive material can be used to determine the characteristic of the fracture.

### EXAMPLE #4

The system of Example #1, further featuring the pressure sensor being positioned in the wellbore for detecting the pressure wave generated by the flow traversing the perforation or the flow moving in the fracture zone.

### EXAMPLE #5

The system of Example #1, further including an oscillator positioned in the wellbore for generating a steady pressure oscillation at a specific frequency. The pressure sensor can be positioned in the wellbore for measuring a response of the fracture zone to the steady pressure oscillation. The response can be used to determine the characteristic of the fracture.

### EXAMPLE #6

The system of Example #1, further including a communication circuit communicatively coupled to the electromagnetic sensors and the pressure sensor for communicating data based on measurements from the electromagnetic sensors and the pressure sensor to a processing device at a surface of the wellbore.

### EXAMPLE #7

The system of Example #1, further featuring the perforation including a plurality of perforations. The pressure sensor includes a plurality of pressure sensors. The origin of the pressure wave can be determined based on more than one pressure sensor detecting the pressure wave. The origin of the pressure wave can be used to evaluate stimulation of the fracture zone.

### EXAMPLE #8

An assembly can include a tubular body, electromagnetic field generators, electromagnetic sensors, and a pressure sensor. The tubular body can be positioned in a wellbore for allowing a flow of treatment fluid to pass through a stimulation zone of the wellbore. The electromagnetic field generators can be coupled to the tubular body for generating electromagnetic fields in different segments of the wellbore. The electromagnetic sensors can be coupled to the tubular body for determining an amount of the flow traversing a perforation into a fracture zone based on measuring data about the flow passing through the electromagnetic fields. The pressure sensor can be coupled to the tubular body for detecting a pressure wave generated by the flow. The pressure wave and the amount of the flow traversing the perforation can be used to determine a characteristic of a fracture in the fracture zone.

### EXAMPLE #9

The assembly of Example #8, further featuring the electromagnetic sensors including a first electromagnetic sensor and a second electromagnetic sensor. The first electromagnetic sensor for measuring a first density of conductive material in the flow passing through a first electromagnetic field of the electromagnetic fields located in a first segment of the tubular body that is closer than the perforation to a source of the flow. The second electromagnetic sensor for measuring a second density of the conductive material in the flow passing through a second electromagnetic field of the electromagnetic fields located in a second segment of the tubular body that is farther than the perforation from the source of the flow. A difference in the first density and the second density can be used to determine the amount of the flow traversing the perforation into the fracture zone.

### EXAMPLE #10

The assembly of Example #9, further featuring the first electromagnetic sensor or the second electromagnetic sensor being positioned for detecting a distribution of the conductive material in the fracture. The distribution of the conductive material can be used to determine the characteristic of the fracture and the conductive material can include a proppant.

### EXAMPLE #11

The assembly of Example #8, further including an oscillator coupled to the tubular body for generating a steady pressure oscillation at a specific frequency. The pressure sensor can be positioned in the wellbore to measure a response of the fracture zone to the steady pressure oscillation. The response can be used to determine the characteristic of the fracture.

### EXAMPLE #12

The assembly of Example #8, further including a diverter, an inflatable packer, and a processing device. The diverter can be coupled to the tubular body for preventing a proppant in the treatment fluid from filling a region between the tubular body and the perforation. The inflatable packer can be coupled to the tubular body for sealing the stimulation zone from another section of the wellbore. The processing device can be coupled to the tubular body for determining the characteristic of the fracture based on the amount of the flow traversing the perforation and the pressure wave.

### EXAMPLE #13

The assembly of Example #8, further featuring the perforation including a plurality of perforations. The pressure sensor can include a plurality of pressure sensors. A specific perforation of the plurality of perforations can be identified as an origin of the pressure wave based on detecting the pressure wave by more than one pressure sensor. The origin of the pressure wave can be used to evaluate stimulation of the fracture zone.

### EXAMPLE #14

The assembly of Example #8, further including a coiled tubing and a communication media. The coiled tubing can be coupled to the tubular body for fluidly coupling the tubular body to a source of the flow. The communication media can be positioned in the coiled tubing for communicatively coupling the electromagnetic sensors and the pressure sensor to a processing device.

### EXAMPLE #15

A method can include measuring data about a flow of treatment fluid passing through a first segment and a second segment of a tubular body positioned in a wellbore using electromagnetic sensors. The first segment can be closer than a perforation in the wellbore to a source of the flow. The second segment can be farther than the perforation from the source of the flow. The method can further include detecting a pressure wave generated from a portion of the flow traversing a perforation into a fracture zone or the flow moving in the fracture zone using a pressure sensor coupled to the tubular body. The method can further include determining a characteristic of a fracture in the fracture zone based on the data and the pressure wave.

### EXAMPLE #16

The method of Example #15, further featuring measuring the data about the flow including measuring a first density of conductive material in the treatment fluid passing through a first electromagnetic field in the first segment of the tubular body. Measuring the data about the flow further including measuring a second density of the conductive material passing through a second electromagnetic field in the second segment of the tubular body.

### EXAMPLE #17

The method of Example #16, further including determining an amount of the flow traversing the perforation based on a difference between the first density and the second density. The method further including determining a distribution of the conductive material in the fracture zone using the electromagnetic sensors. The method further including detecting a reflection of a pressure pulse signal by the pressure sensor, the pressure pulse signal being generated by a change in a pumping rate of the flow. The method further featuring that determining the characteristic of the fracture can be based on the amount of the flow traversing the perforation, the distribution of the conductive material, and the reflection of the pressure pulse signal.

### EXAMPLE #18

The method of Example #15, further featuring the perforation including a plurality of perforations. The pressure sensor can include a plurality of pressure sensors. The method further including determining a specific perforation of the plurality of perforations through which the flow passed to generate the pressure wave based on more than one pressure wave detecting the pressure wave.

### EXAMPLE #19

The method of Example #15, further including communicating information based on the data and the pressure wave across a fiber optic cable to a processing device at a surface of the wellbore.

### EXAMPLE #20

The method of Example #15, further including scanning a casing of the wellbore for defects using the electromagnetic sensors as the tubular body is inserted into the wellbore.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
electromagnetic sensors positionable in a wellbore having a perforation for determining an amount of the flow traversing the perforation into a fracture zone, the electromagnetic sensors comprising:
a first electromagnetic sensor positionable in a first segment of the wellbore that is closer than the perforation to a surface of the wellbore; and
a second electromagnetic sensor positionable in a second segment of the wellbore that is farther than the perforation from the surface of the wellbore; and
a pressure sensor positionable in the wellbore for detecting a pressure wave generated by the flow, the pressure wave and the amount of the flow traversing the perforation being usable to determine a characteristic of a fracture in the fracture zone.

2. The system of claim 1, wherein the first electromagnetic sensor is positionable in the first segment of the wellbore for measuring a first density of conductive material in the treatment fluid as the flow passes through a first electromagnetic field in the first segment of the wellbore, wherein the second electromagnetic sensor is positionable in the second segment of the wellbore for measuring a second density of the conductive material in the treatment fluid as the flow passes through a second electromagnetic field in the second segment of the wellbore, wherein a difference between the first density and the second density is usable to determine the amount of the flow that is traversing the perforation into the fracture zone.

3. The system of claim 2, wherein the first electromagnetic sensor or the second electromagnetic sensor are positionable for detecting a distribution of the conductive material in the fracture zone, wherein the distribution of the conductive material is usable to determine the characteristic of the fracture.

4. The system of claim 1, wherein the pressure sensor is positionable in the wellbore for detecting the pressure wave generated by the flow traversing the perforation or the flow moving in the fracture zone.

5. The system of claim 1, further comprising an oscillator positionable in the wellbore for generating a steady pressure oscillation at a specific frequency, wherein the pressure sensor is further positionable in the wellbore for measuring a response of the fracture zone to the steady pressure oscillation, the response being usable to determine the characteristic of the fracture.

6. The system of claim 1, further comprising a communication circuit communicatively coupleable to the electromagnetic sensors and the pressure sensor for communicating data based on measurements from the electromagnetic sensors and the pressure sensor to a processing device at a surface of the wellbore.

7. The system of claim 1, wherein the perforation comprises a plurality of perforations, wherein the pressure sensor comprises a plurality of pressure sensors, wherein an origin of the pressure wave is determinable based on more than one pressure sensor detecting the pressure wave, the origin of the pressure wave being usable to evaluate stimulation of the fracture zone.

8. An assembly comprising:
a tubular body positionable in a wellbore for allowing a flow of treatment fluid to pass through a stimulation zone of the wellbore;
electromagnetic field generators coupled to the tubular body for generating electromagnetic fields in different segments of the wellbore;
electromagnetic sensors coupled to the tubular body for determining an amount of the flow traversing a perforation into a fracture zone based on measuring data about the flow passing through the electromagnetic fields; and
a pressure sensor coupled to the tubular body for detecting a pressure wave generated by the flow, the pressure wave and the amount of the flow traversing the perforation being usable to determine a characteristic of a fracture in the fracture zone.

9. The assembly of claim 8, wherein the electromagnetic sensors comprise:
a first electromagnetic sensor for measuring a first density of conductive material in the flow passing through a first electromagnetic field of the electromagnetic fields located in a first segment of the tubular body that is closer than the perforation to a source of the flow;
a second electromagnetic sensor for measuring a second density of the conductive material in the flow passing through a second electromagnetic field of the electromagnetic fields located in a second segment of the tubular body that is farther than the perforation from the source of the flow,
wherein a difference in the first density and the second density is usable to determine the amount of the flow traversing the perforation into the fracture zone.

10. The assembly of claim 9, wherein the first electromagnetic sensor or the second electromagnetic sensor are positionable for detecting a distribution of the conductive material in the fracture, wherein the distribution of the conductive material is usable to determine the characteristic of the fracture and the conductive material comprises a proppant.

11. The assembly of claim 8, further comprising an oscillator coupled to the tubular body for generating a steady pressure oscillation at a specific frequency, wherein the pressure sensor is further positionable in the wellbore for measuring a response of the fracture zone to the steady pressure oscillation, the response being usable to determine the characteristic of the fracture.

12. The assembly of claim 8, further comprising:
a diverter coupleable to the tubular body for preventing a proppant in the treatment fluid from filling a region between the tubular body and the perforation;
an inflatable packer coupleable to the tubular body for sealing the stimulation zone from another section of the wellbore; and
a processing device coupleable to the tubular body for determining the characteristic of the fracture based on the amount of the flow traversing the perforation and the pressure wave.

13. The assembly of claim 8, wherein the perforation comprises a plurality of perforations, wherein the pressure sensor comprises a plurality of pressure sensors, wherein a specific perforation of the plurality of perforations is identifiable as an origin of the pressure wave based on detecting the pressure wave by more than one pressure sensor, the origin of the pressure wave being usable to evaluate stimulation of the fracture zone.

14. The assembly of claim 8, further comprising:
a coiled tubing coupleable to the tubular body for fluidly coupling the tubular body to a source of the flow;
a communication media positionable in the coiled tubing for communicatively coupling the electromagnetic sensors and the pressure sensor to a processing device.

15. A method comprising:
measuring data about a flow of treatment fluid passing through a first segment and a second segment of a tubular body using electromagnetic sensors, the tubular body being positioned in a wellbore, the first segment being closer than a perforation in the wellbore to a source of the flow, and the second segment being farther than the perforation from the source of the flow;
detecting a pressure wave generated from a portion of the flow traversing the perforation into a fracture zone or the flow moving in the fracture zone using a pressure sensor coupled to the tubular body; and
determining a characteristic of a fracture in the fracture zone based on the data and the pressure wave.

16. The method of claim 15, wherein measuring the data about the flow comprises:
measuring a first density of conductive material in the treatment fluid passing through a first electromagnetic field in the first segment of the tubular body; and
measuring a second density of the conductive material passing through a second electromagnetic field in the second segment of the tubular body.

17. The method of claim 16, further comprising:
determining an amount of the flow traversing the perforation based on a difference between the first density and the second density;
determining a distribution of the conductive material in the fracture zone using the electromagnetic sensors; and
detecting a reflection of a pressure pulse signal by the pressure sensor, the pressure pulse signal being generated by a change in a pumping rate of the flow,
wherein determining the characteristic of the fracture is further based on the amount of the flow traversing the perforation, the distribution of the conductive material, and the reflection of the pressure pulse signal.

18. The method of claim 15, wherein the perforation comprises a plurality of perforations, wherein the pressure sensor comprises a plurality of pressure sensors, the method further comprising:
determining a specific perforation of the plurality of perforations through which the flow passed to generate the pressure wave based on more than one pressure wave detecting the pressure wave.

19. The method of claim 15, further comprising:
communicating information based on the data and the pressure wave across a fiber optic cable to a processing device at a surface of the wellbore.

20. The method of claim 15, further comprising:
scanning a casing of the wellbore for defects using the electromagnetic sensors as the tubular body is inserted into the wellbore.
